(19) United States
(12) Patent Application Publication
(10) Pub. No.: US 2022/0136814 A1
(43) Pub. Date: May 5, 2022

(54) MOBILE ORDNANCE DISPOSAL SYSTEM

(71) Applicant: GOLDEN WEST HUMANITARIAN FOUNDATION, Woodland Hills, CA (US)

(72) Inventors: Leon Len Austin, Woodland Hills, CA (US); John Arthur Wright, Wellingborough (GB); Roger Hess, Fife, WA (US)

(73) Assignee: GOLDEN WEST HUMANITARIAN FOUNDATION, Woodland Hills, CA (US)

(21) Appl. No.: 17/516,674

(22) Filed: Nov. 1, 2021

Related U.S. Application Data
(60) Provisional application No. 63/107,981, filed on Oct. 30, 2020.

(51) Int. Cl. F42D 5/04; B23D 59/04; B23D 53/04; B23D 53/00

(52) U.S. Cl. CPC F42D 5/04; B23D 53/001; B23D 53/04; B23D 59/04

(57) ABSTRACT

A mobile ordnance disposal system to dispose of unexploded ordnance in situ by cutting open the ordnance casing and subjecting the explosive material to heat in order to burn the explosive material held within the casing in a controlled manner instead of generating an explosion to effect disposal. By using the system, the operator may remain at safe, remote distance controlling the system operation.

### CROSS REFERENCE TO RELATED APPLICATION

This application claims the benefit of the prior-filed, co-pending provisional patent application, Ser. No. 63/107,981, filed Oct. 30, 2020, which is hereby incorporated by reference.

### BACKGROUND OF THE INVENTION

### Field of the Invention

The present invention relates to systems, apparatuses and methods for disposing of unexploded ordnance.

### Description of the Related Art

Means for disposing of unexploded ordnance known in the prior art typically use or require explosives or heat generating chemicals, such as Thermite, which may be relatively unsafe to use and/or are often difficult to obtain or transport. In addition to difficulties presented by transport of hazardous materials, such means present significant risk to users who must handle such materials while in close proximity to unexploded ordnance.

What is needed is a device, system and method that provides the operator the ability to remotely disarm and dispose of unexploded ordnance in the field, using readily available materials and with minimal risk to the operator or others.

### SUMMARY OF THE INVENTION

One or more embodiments of the present invention may comprise a system and apparatus to dispose of unexploded ordnance by subjecting the explosive material to heat while the system operator is at safe, remote distance, thereby burning the explosive material instead of generating an explosion. Heat sufficient to initiate a burn is provided via a heat source such as a gas burner that may operate using a common fuel gas such as butane. The flow of gas and the burner ignition are controlled remotely by an operator using a control switch box. Because the system itself does not use explosives to detonate unexploded ordnance, as is typical in the prior art, the system does not require personnel specialized in the handling of explosives, does not require specialized storage facilities, and can be readily transported by commercial air freight carriers without special arrangements. Because butane gas is readily available in most counties, it may be obtained on site without the need for air transport with other system components.

A mobile ordnance disposal system according to the present invention may include a first non-explosive ordnance disposal subsystem (first subsystem) for safely and remotely burning explosive material in unexploded ordnance, and a second mobile bomb cutting subsystem (second subsystem) for safely and remotely cutting unexploded ordnance casings to expose the unexploded explosive material for combustion by the first subsystem. The first subsystem includes a main control case for housing main control case components including gas flow and electrical control and supply components. A burner assembly located remotely from the main control case and at the ordnance site provides a heat source to ignite and burn unexploded ordnance. The burner assembly includes a gas burner head, gas valve, shroud, and gas ignition source (igniter). A control switch box is located further remotely from the burner assembly and from the main control case for remote operation and control of main control case components. The second subsystem may include a powered saw for cutting into an unexploded ordnance casing, such as a hydraulically supported industrial handsaw, a control box for locally controlling operation of the saw, a saw bench for supporting ordnance positioned for cutting, and means for raising and lowering the saw blade relative to the ordnance casing. The bandsaw may include a coolant tank for holding liquid blade coolant, and one or more coolant nozzles positioned proximate the saw blade for delivering coolant upon the saw blade during a cutting operation.

A camera is typically positioned proximate the second subsystem to provide real time video remotely viewable during operation of the second subsystem. A camera may also be positioned proximate the first subsystem to provide real time video remotely viewable during operation of the first subsystem.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a diagram illustrating components of an embodiment of an ordnance disposal system and apparatus according to the present invention.

FIG. 2 is an elevational view of a burner assembly.

FIG. 3 is an elevational view of a burner assembly.

FIG. 4 is right side perspective view of the main control case showing the gas outlet, the ignition wires plugged into ignition wire receptacles in the main control case, and showing the 6-volt battery plugged into the 6-volt battery receptacle.

FIG. 5 is a left side perspective view of the main control case of FIG. 4 showing the gas inlet, a 12-volt battery receptacle, a 12-volt battery pack plugged into the 12-volt battery receptacle, a gas cannister in fluid connection with the main control case via a cannister hose attached to the main control case with a quick release connector, and an extension cable connector.

FIG. 6 is a top plan view of a control switch box.

FIG. 7 is an electrical schematic diagram of a control switch box.

FIG. 8 is a top perspective view showing internal components of a main control case including a solenoid to control gas flow between the gas inlet and outlet, and a voltage amplifier for supplying high voltage to the burner igniter.

FIG. 9 is a simplified overall electrical schematic diagram of the system.

FIG. 10 is a schematic diagram of the electrical wiring of the main control case.

FIG. 11 is an elevation view of the MBCS subsystem when packed for transport to a disposal location.

FIG. 12 is a perspective view of the MBCS subsystem when deployed and showing the bandsaw positioned above an unexploded ordnance.

FIG. 13 is a perspective view of the bandsaw in operation showing cooling fluid or coolant flooding the bandsaw blade from the coolant nozzle.

FIG. 14 is a perspective view showing the bandsaw having cut through an ordnance casing.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

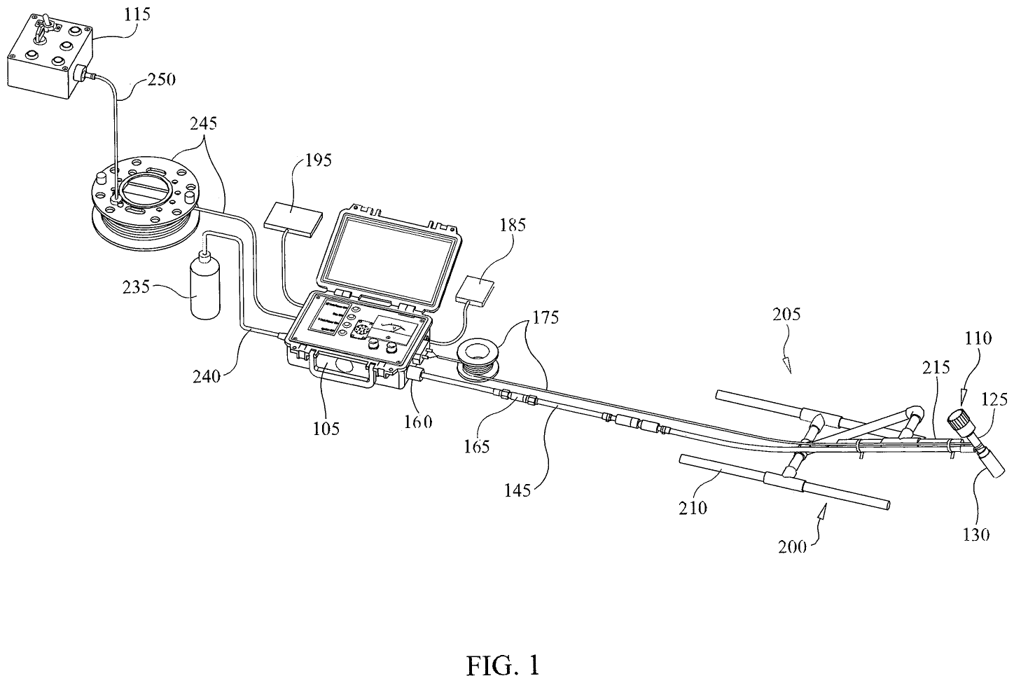

Referring now to the drawings, FIGS. 1 through 14 illustrate embodiments of a mobile ordnance disposal system 100 (MODS system 100) in accordance with the present invention, and components thereof. The system comprises at least two subsystems, a non-explosive ordnance disposal subsystem 101 (NEDS subsystem 101) for safely and remotely burning explosive material found in unexploded ordnance, and a mobile bomb cutting subsystem 300 (MBCS subsystem 300) for safely and remotely cutting bomb and munition casings to expose the unexploded explosive material for disposal by the NEDS subsystem 101.

With particular reference to FIG. 1, a diagram illustrating components of an embodiment of an ordnance disposal system according to the present invention, an embodiment of a NEDS subsystem 101 may comprise a main control case 105 for housing gas flow and electrical control and supply components, a burner assembly 110 for providing a heat source to ignite and burn unexploded ordnance, and a control switch box 115 for remote operation and control of main control case 105 components.

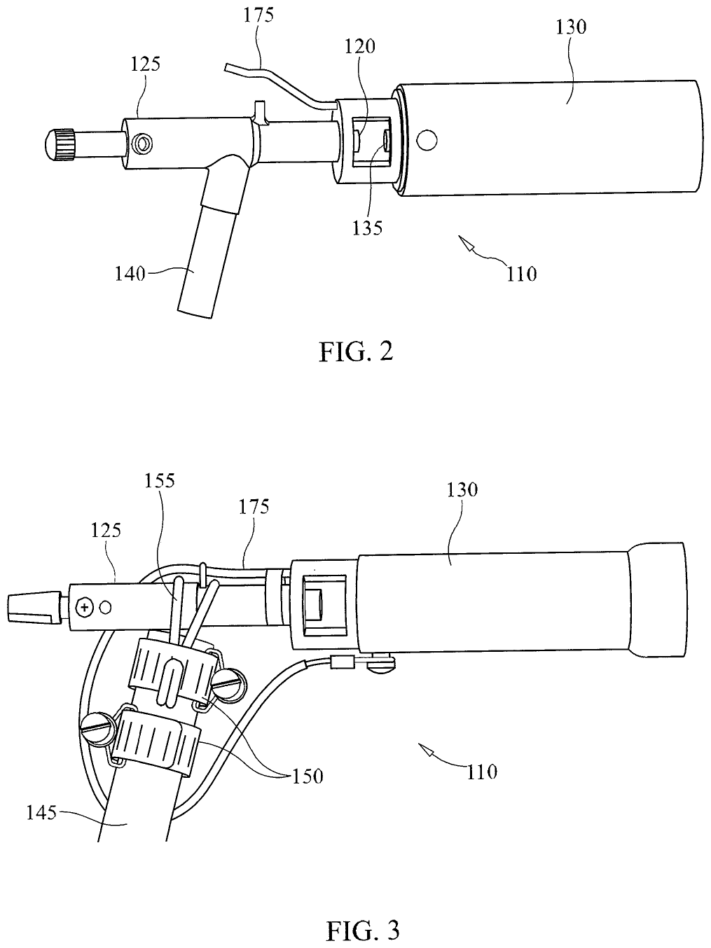

FIG. 2 is an elevational view of a burner assembly 110, which may comprise a gas burner head 120, gas valve 125, shroud 130, electrical spark igniter 135, and hose fitting 140. To set up the burner assembly 110 for operation, the gas valve 125 is fully opened and locked into the open position using a set screw. The burner assembly 110 is attached to the proximate end of a gas hose 145 by sliding the gas hose 145 over the hose fitting 140. The gas hose 145 may be held in place using hose clips 150 or other operable means. FIG. 3 is an elevational view of a burner assembly 110 showing the gas hose 145 attached to the hose fitting 140 using hose clips 150. By way of example, an appropriately dimensioned gas hose 145 may be approximately 1.5 meters long, with an inside diameter of 6.4 mm, an outside diameter of 12 mm, and a pressure rating of approximately 5.5 bar or 80 psi. Gas hoses 145 used for welding operations are typically of appropriate dimensions, pressure ratings and compositions for use in the NEDS subsystem 101. Due to softening of the gas hose 145 during operation of the NEDS subsystem 101, and the gas pressure exerted against the burner assembly 110 during operation, connection of the gas hose 145 to the hose fitting 140 may be augmented by wrapping wire of sufficient resilience (retention wire 155) around the body of the burner assembly 110 and also around a hose clip 150. Other means for securing the gas hose 145 to the burner assembly 110 may be utilized, such as threaded fittings.

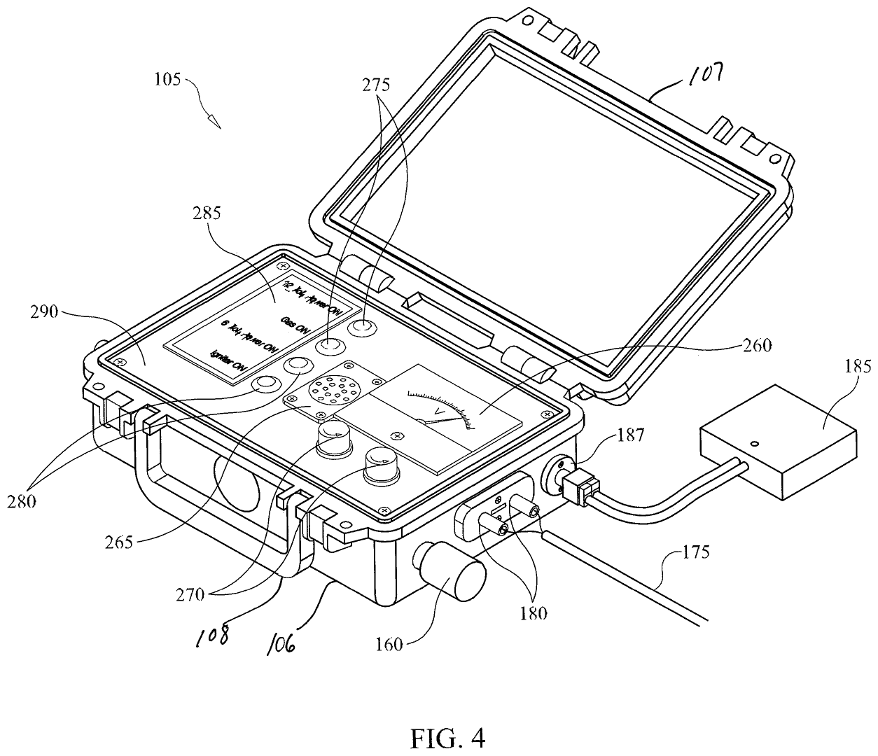

The other, distal end of the gas hose 145 is connected to a gas outlet fitting 160 on the main control case 105 (see FIGS. 1 and 4). A flashback arrester 165 is provided inline to prevent flashback during NEDS subsystem 101 operations, i.e. to prevent gas from burning back down the gas hose 145 from the burner assembly 110. The gas hose 145 may be connected to the gas control assembly 170 within the main control 105 case via a quick connecter known in the prior art.

Electrical igniter wire 175 of sufficient length (typically approximately 1.5 meters) is connected at one end to the igniter 135 and at the other end to the main control case 105 ignition wire terminals or receptacles 180 (see FIG. 4). FIG. 1 shows a top perspective view of a coil of burner ignition wire 175 for electronically connecting the burner igniter 135 to the main control case 105.

When the NEDS subsystem 101 is in operation, the burner assembly 110 is typically positioned above the unexploded ordnance upon a burner stand 200. FIG. 1 shows a top perspective view of a burner assembly 110 operably positioned and secured to a burner stand 200 to form a burner stand assembly 205. A burner stand 200 may comprise sections of electrical conduit tubing, or other operable materials, connected to one another to form a base 210 and an arm 215. Electrical conduit tubing is an appropriate material because it is typically used to house electrical wire and is flame and heat resistant. The base 210 of the burner stand 200 rests upon the ground and the arm 215 projects upward from the base 210. The burner assembly 110 may be attached to the arm 210 using cable ties or other operable means (see FIG. 1) and is oriented to direct the shroud 130 and gas burner head 120 downward and a short distance above ordnance positioned below the burner assembly 110.

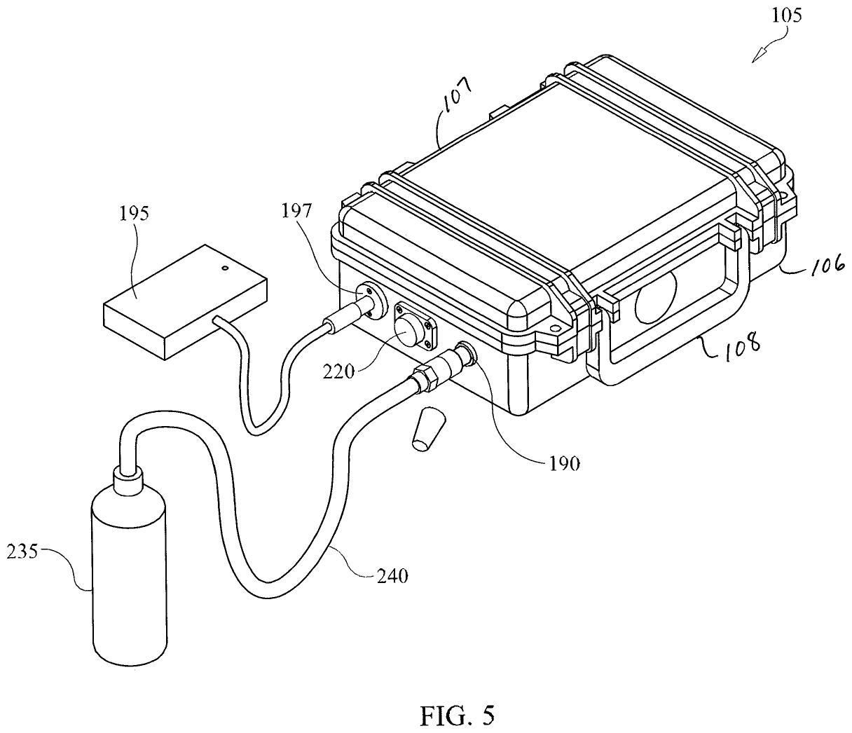

FIG. 4 is front, right perspective view of the main control case 105 showing the gas outlet 160, the ignition wires 175 plugged into ignition wire receptacles 180 in the main control case 105 and showing the 6-volt battery 185 plugged into the 6-volt battery receptacle 187. FIG. 5 is a front, left perspective view of the main control case of FIG. 4 showing the gas inlet 190, a 12-volt battery receptacle 197, and extension cable connector 220. FIG. 5 also shows a 12-volt battery pack 195 plugged into the 12-volt battery receptacle 197. FIG. 4 shows a 6-volt battery pack 185 plugged into the 6-volt battery receptacle 187. The main control case 105 typically comprises a main body 106 for housing the main control case components and a lid 107 so that the control case 105 can be closed and sealed during transport. A handle 108 attached to the main body 106 may be provided for carrying.

The main control case 105 contains a gas control assembly 170, including gas inlets 190 and outlets 160 and an interposed gas control solenoid valve 225. The main control case 105 also includes a voltage amplifier 230 to generate high voltage electrical transmission from the main control case 105, via the burner ignition wire 175, to the igniter 135. Fig. shows a gas cannister 235 in fluid connection with the main control case 105 via a cannister hose 240 attached to gas inlet of the main control case 105 with a quick release connector.

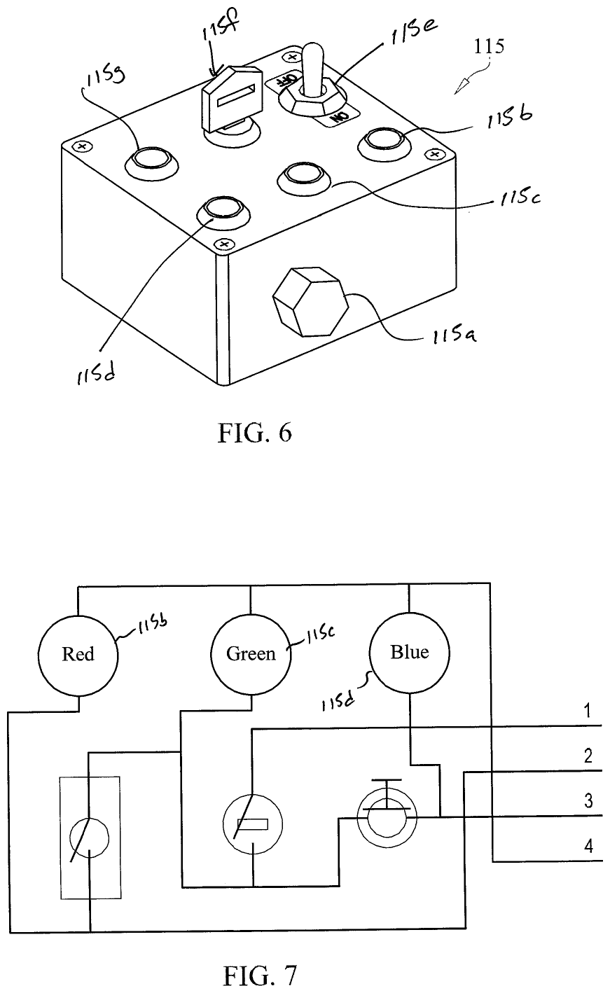

FIG. 1 shows a top perspective view of a coil of extension cable 245 used to connect the main control case 105 to the control switch box 115. In certain embodiments, the control switch box 115 may be connected to the extension cable 245 by an intermediate lead cable 250. FIG. 6 is a rear perspective view of a control switch box 115. The control switch box 115 includes a control or lead cable 250 connection 115a (shown with cover in place), a Solenoid ON indicator light 115b, a Key ON indicator light 115c, an Igniter ON light 115d, a solenoid switch 115e, a key switch 115f, and an igniter button 115g.

FIG. 7 is an electrical schematic diagram of a control switch box 115. The control switch box 115 is used to send a signal to the main control case 105 to open the gas solenoid 225 and also used to close the ignition relay 255 to allow high voltage to generate a spark at the igniter 135, thereby igniting the gas flowing from the burner head 120 during operation. Line 1 indicates a ground from the main control case 105. Lines 2 and 3 as shown indicate logic condition “0” for relay operation. Line 4 indicates a 5 volt supply from the main control case 105.

FIG. 4 is a view of a main control case 105 display panel showing a voltmeter 260 for indicating the 12-volt supply voltage, an air inlet 265 for ventilating the interior of the case 105, fuses 270 for protecting the 12-volt and 6-volt electrical systems, 12-volt LEDs 275 for indicating 12-volt operation and 6-volt LEDs 280 for indicating 6-volt operation. Printed indicia identifying the function of the above-referenced LED lights are provided proximate to the LEDs, as shown, for example, on a brass plate 285 affixed to the main case display board 290.

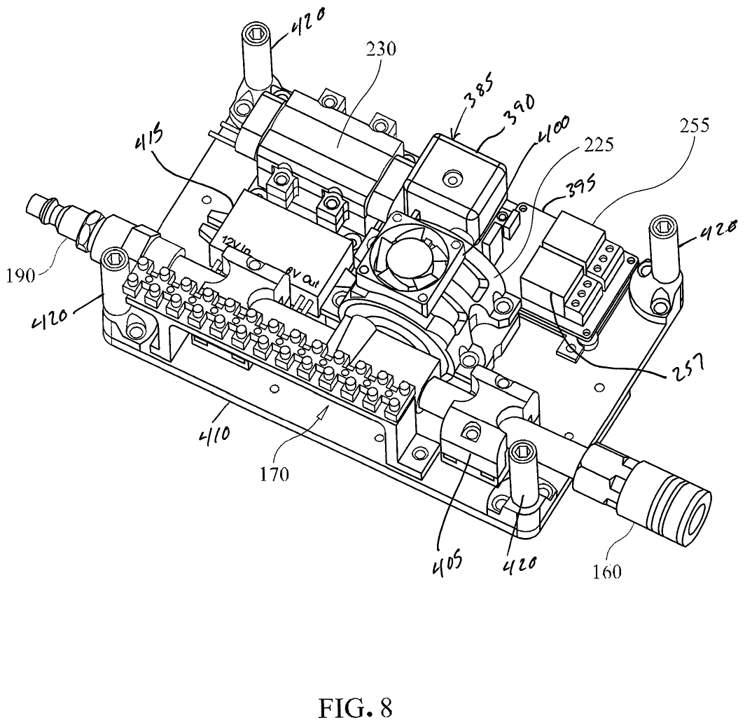

FIG. 8 is a top perspective view showing internal components of a main control case 105 including the gas solenoid 225 to control gas flow between the gas inlet 190 and gas outlet 160, and a voltage amplifier 230 for supplying high voltage to the burner igniter 135. Further components include a high voltage terminal 385 (shown with terminal cover 390 in place), a double relay module control board 395, the ignition relay 255 and solenoid relay 257 (both mounted on board 395), a cooling fan 400 for cooling the electronic components during operation, a control case mounting panel 410 upon which the components shown in FIG. 8 are mounted, a 12 to 5 volt regulator, and support posts 420 upon which the display board 290 is mounted. Clamps 405 are provided for holding the gas pipe routed through the main control case 105 so that flow of gas may be controlled by the adjacent solenoid 225.

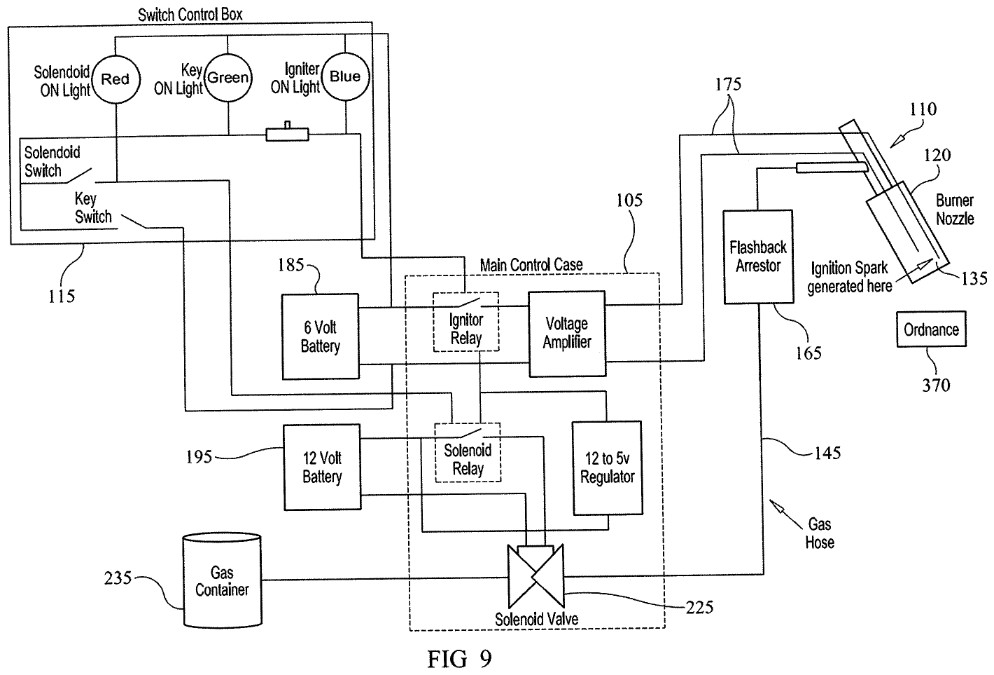

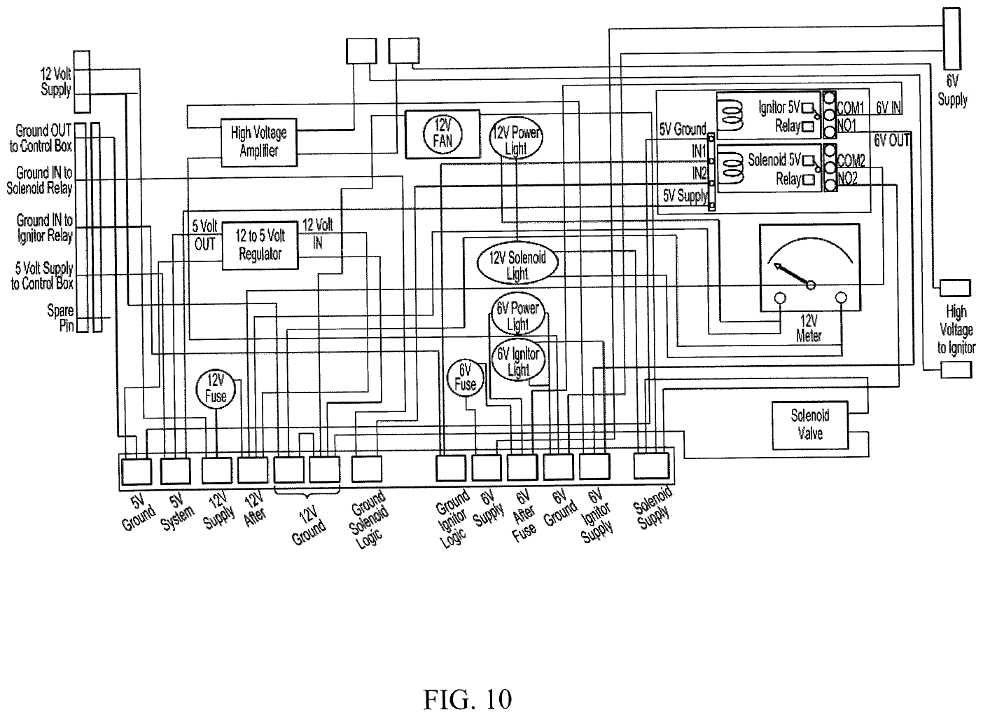

FIG. 9 is a simplified overall electrical schematic diagram of the system. FIG. 10 is a schematic diagram of the electrical wiring of the main control case.

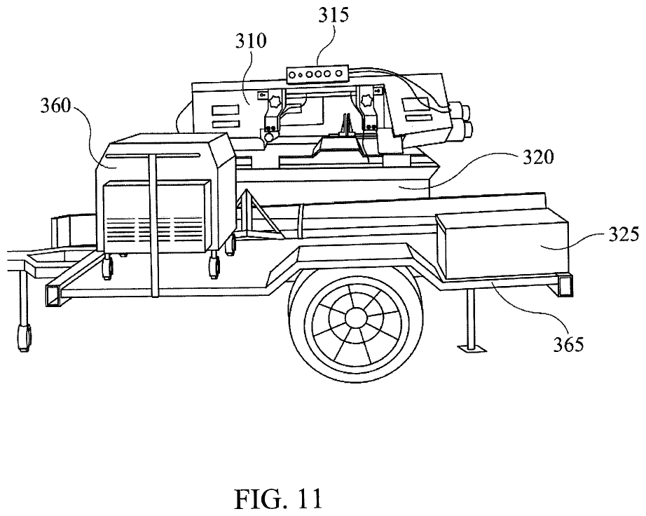

FIGS. 11 through 14 illustrate embodiments of the MBCS subsystem 300 components of a MODS system 100. Such components may include a bandsaw 305 for cutting into unexploded ordnance casings, bandsaw frame 310, control box 315, coolant tank 320, toolbox 325, remote controlled camera 330, hoist 335, bandsaw cooling unit 340, saw bench 345, hydraulic raising/lowering unit 350, clamps 355, and generator 360. All such listed components may be mounted upon and/or transported to the disposal site on a trailer 365. FIG. 11 is an elevation view of the MBCS subsystem 300 when packed for transport upon the trailer 365 to a disposal location.

The bandsaw 305 is mounted and held within the bandsaw frame 310 and is powered by the generator 360. The bandsaw frame 310 is held by a hinged arm (or equivalent hinged/articulated structure) that is attached to a base so that the bandsaw 305 may be positioned above unexploded ordnance 370 for cutting into the ordnance casing 375. The casing 375 is held securely in position between clamps 355 that are mounted on the saw bench 345. The ordnance 370 is thereby held by the clamps 355 upon the saw bench 345 and below the bandsaw 305 after being lifted onto the saw bench 345 by the hoist 335.

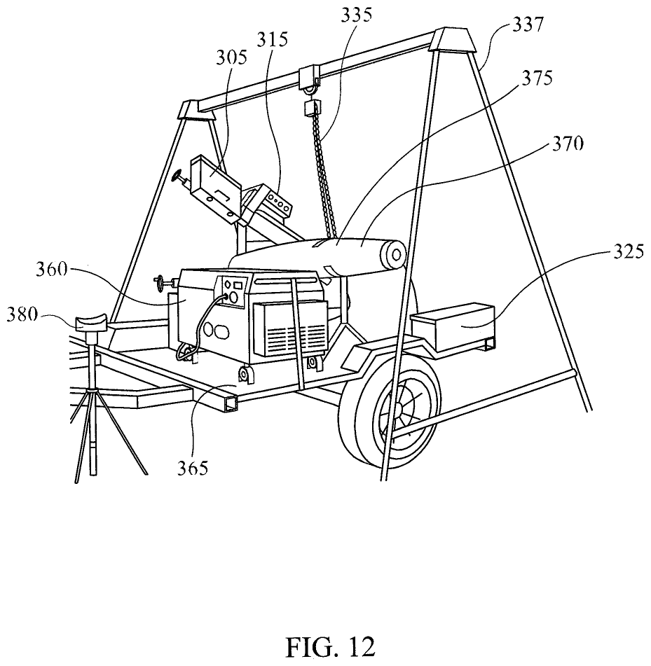

FIG. 12 is a perspective view of the MBCS subsystem 300 when deployed and showing the bandsaw 305 positioned above an unexploded ordnance 370 that has been lifted onto the saw bench 345 using the hoist 335. The hoist 335 is shown hanging from and mounted on a hoist frame 337 that may be carried on the trailer 365 when disassembled. Operation of the bandsaw 305 may be observed remotely via a remote-control camera 380 positioned to transmit images of the MBCS subsystem 300, particularly the bandsaw 305 and ordnance 370.

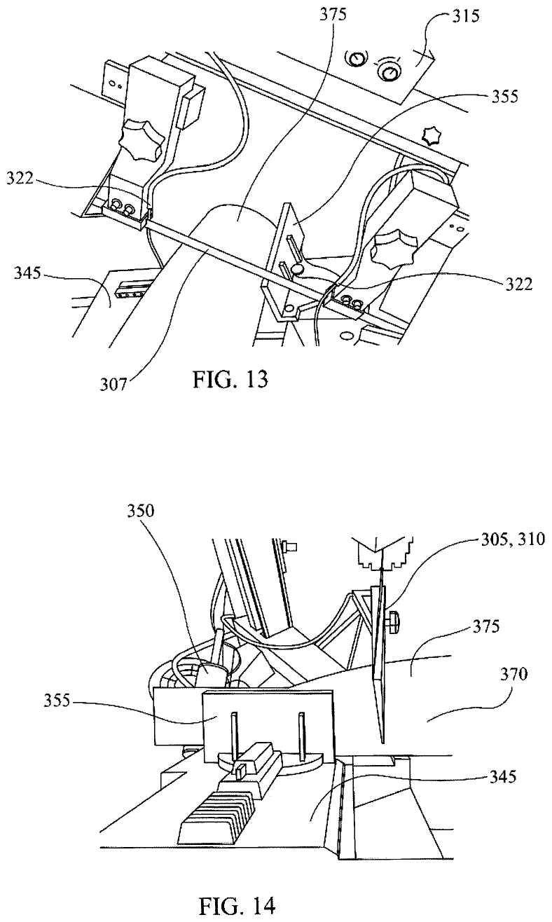

While cutting, the bandsaw blade 307 is cooled and lubricated using a detergent and water-based coolant that is pumped from the coolant tank 320 to the coolant nozzle 322 (see FIG. 13). Coolant formulations of detergent to water at a 1:8 ratio may be used, for example. FIG. 13 is a perspective view of the bandsaw 305 in operation showing cooling fluid or coolant flooding the bandsaw blade 307 from the coolant nozzle 322. FIG. 14 is a perspective view showing the bandsaw 305 having cut through an ordnance casing 375.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A mobile ordnance disposal system comprising:
a first non-explosive ordnance disposal subsystem (first subsystem) for safely and remotely burning explosive material in unexploded ordnance;
a second mobile bomb cutting subsystem (second subsystem) for safely and remotely cutting unexploded ordnance casings to expose the unexploded explosive material for combustion by the first subsystem;
said first subsystem comprising a main control case for housing main control case components including gas flow and electrical control and supply components, a burner assembly for providing a heat source to ignite and burn unexploded ordnance, and a control switch box for remote operation and control of main control case components, said burner assembly comprising a gas burner head, gas valve, shroud, and gas igniter; and
said second subsystem comprising a powered saw for cutting into an unexploded ordnance casing, a control box for locally controlling operation of the saw, a saw bench for supporting ordnance positioned for cutting, and means for raising and lowering the saw blade relative to the ordnance casing.

2. The mobile ordnance disposal system of claim 1 further comprising a gas hose for conveying flammable gas to the burner assembly, said gas hose connecting a hose fitting of said burner assembly to a gas outlet fitting of said main control case and for receiving a controlled flow of gas from said gas outlet fitting.

3. The mobile ordnance disposal system of claim 2 further comprising a flashback arrester interposed between sections of said gas hose to prevent flashback during operation of said first subsystem.

4. The mobile ordnance disposal system of claim 1 further comprising a coolant tank for holding liquid blade coolant and one or more coolant nozzles positioned proximate the saw blade for delivering coolant upon the saw blade during a cutting operation.

5. The mobile ordnance disposal system of claim 1 further comprising a camera positioned proximate the first subsystem to provide real time video remotely viewable during operation of the first subsystem.

6. The mobile ordnance disposal system of claim 1 further comprising a camera positioned proximate the second subsystem to provide real time video remotely viewable during operation of the second subsystem.

7. A system and apparatus to expose and combust explosive material in unexploded ordnance while an operator is remotely located a safe distance from said apparatus, said system and apparatus comprising:
a powered blade for cutting at least partially through an ordnance casing to expose explosive material, and
a heat source positioned proximate said ordnance applying sufficient heat and flame to said explosive material to initiate ignition of said explosive material,
said blade and said heat source controlled remotely by an operator.
